(19) United States
(12) Patent Application Publication
(10) Pub. No.: US 2005/0144588 A1
(43) Pub. Date: Jun. 30, 2005

(54) System and method for embedded processor firmware development

(75) Inventor: Dan M. White, Hudson, MA (US)

Correspondence Address: Daly, Crowley & Mofford, LLP;c/o PortfolioIP, P.O. Box 52050, Minneapolis, MN, 55402, US

(73) Assignee: Intel Corporation

(21) Appl. No.: 10/748,427

(22) Filed: Dec. 30, 2003

(51) Int. Cl. G06F 9/44

(52) U.S. Cl. 717/113; 717/110; 717/120

(57) ABSTRACT

An integrated debugger environment system includes a debugger speedbar to display symbolic information for source code associated with a plurality of firmware programs.

### CROSS REFERENCE TO RELATED APPLICATIONS

Not Applicable.

### STATEMENT REGARDING FEDERALLY SPONSORED RESEARCH

Not Applicable.

### FIELD OF THE INVENTION

The presently disclosed embodiments relate generally to programming hardware devices and, more particularly, to firmware program development systems.

### BACKGROUND OF THE INVENTION

As is known in the art, assembly and other low level languages can be used to program various hardware devices on circuit boards. Embedded programs can be used to program devices on a board as part of an overall system. In general, assembly programming is tightly coupled to the hardware resources, such as data registers. That is, the programmer may control data operations at an individual register level. When debugging a firmware program, it is often desirable to examine the contents of particular registers, memory locations, data structures, and the like.

However, in some conventional Integrated Development Environment (IDE) debuggers for embedded program development, the process to examine a data structure is rather cumbersome and inefficient. To read the value of a field in a data structure, for example, a programmer uses an editor on a symbol file that is output by the assembler to find the address in memory of a structure instance. The address for the structure is generally unique to this invocation of the program so that the same steps are repeated each run of the program. The programmer then goes to a different area of that same symbol file (the structure definition) to determine the structure field offset. From the offset, the programmer calculates the desired address from the structure instance address. Then, the programmer goes to the data memory window of the debugger and reads the value.

Many conventional IDE debuggers have (sub)windows that show symbolic information. Known IDEs include Microsoft Visual Studio and WindRiver Tornado toolset. The VMOD visual modeling tool tool, which is a Computer Aided Design (CAD) tool used for silicon design at Intel, also includes symbolic navigation capability. In the VMOD tool, the user can open windows for hardware description language (HDL), e.g., Verilog, source files and navigate through the variables in the source file using a display on the left-hand side of the window. However, in VMOD this navigation bar is limited to a single source file.

It would, therefore, be desirable to overcome the aforesaid and other disadvantages.

### BRIEF DESCRIPTION OF THE DRAWINGS

The embodiments disclosed herein will be more fully understood from the following detailed description taken in conjunction with the accompanying drawings, in which:

FIG. 1 is a schematic representation of an exemplary integrated development environment (IDE) tool that can be operated on a workstation in accordance with an exemplary embodiment;

FIG. 2 is a pictorial representation of a screen shot of an exemplary IDE tool having a speedbar in accordance with an exemplary embodiment;

FIG. 3 is a pictorial representation of a screen shot of an exemplary top level screen for the IDE system of FIG. 1;

FIG. 4 is a pictorial representation of a screen shot of an exemplary source code screen for the IDE system of FIG. 1;

FIG. 5 is a pictorial representation of a screen shot of an exemplary device resource screen for the IDE system of FIG. 1;

FIG. 6 is a pictorial representation of a screen shot of an exemplary speedbar screen for the IDE system of FIG. 1;

FIG. 7 is a flow diagram showing exemplary processing blocks to implement an embedded firmware development tool in accordance with the disclosed embodiments; and

FIG. 8 is a schematic depiction of an exemplary IDE system having a speedbar in accordance with the present embodiments.

### DETAILED DESCRIPTION OF THE INVENTION

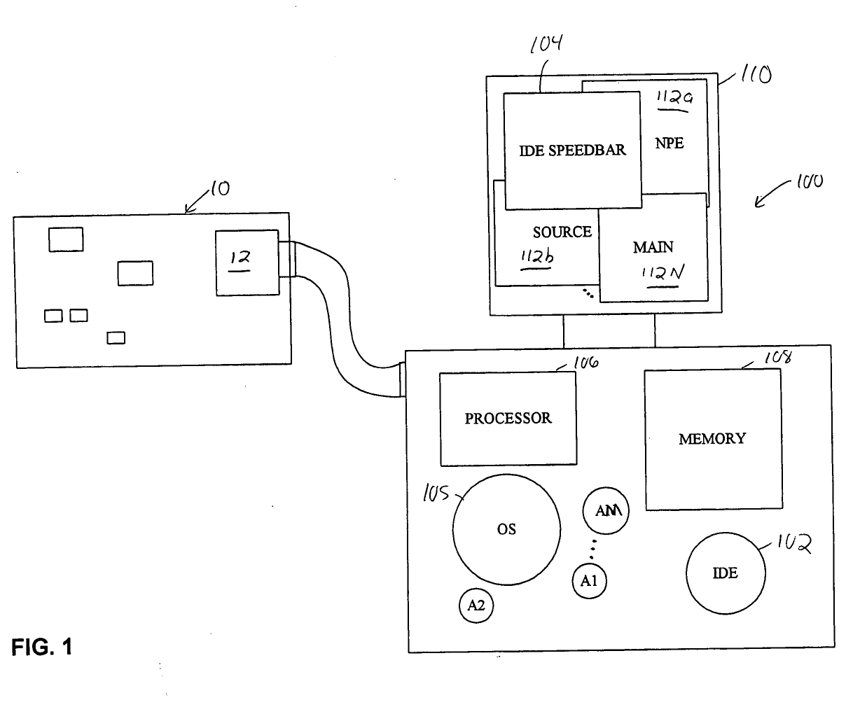

FIG. 1 shows a workstation 100 operating an exemplary integrated development environment (IDE) system 102 having a debugger speedbar 104 in accordance with an illustrative embodiment. In general, the debugger speedbar 104 enhances the efficiency of a programmer debugging an embedded firmware program by providing a mechanism for the programmer to view data words, short words, byte values, structures, register (actual and symbolic name) contents, etc., by displaying the name/address binding and the like.

In one embodiment, the workstation 100 includes an IDE system 102 that communicates with a development circuit board 10 that includes a chip(s) 12 to be programmed. Alternatively, the IDE system can communicate with a application for simulating the chip 12.

Development boards for IDE tools are well known to one of ordinary skill in the art. A variety of development boards for various programmable devices are available from Intel Corporation of Santa Clara, Calif. The IDE system 102 operates on the workstation 100, which runs an operating system 105, such as a Windows-based operating system by Microsoft corporation, on a processor 106 and memory 108.

The IDE system 102 displays on a monitor 110 a series of screens 112a, 112b, 112c, . . . , 112N for interacting with the development board 10 to facilitate the development and debugging of firmware programs for the circuit board/chip 12. For example, an Intel development board having a particular processor, such as an Intel 4XX series network processor, may be used by a customer to develop a firmware program for the processor that will be implemented on a customer circuit board. The IDE system 102 can also communicate with simulation software for the device. Typically, a series of applications A1, A2, . . . , AM also run on the workstation, one of which can provide a simulator for the device 12.

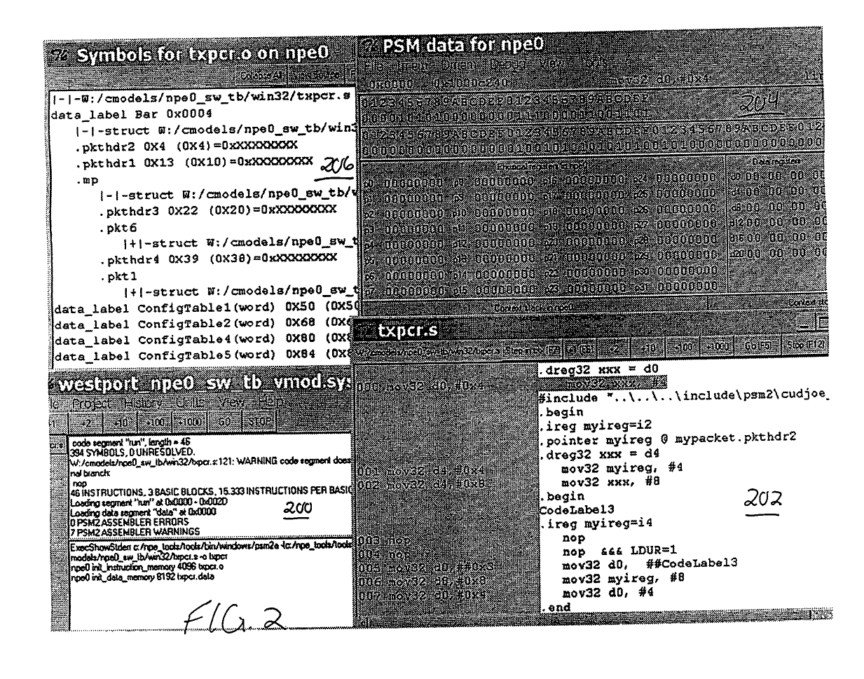

FIG. 2 shows a screen shot of an exemplary display having a series of windows 200, 202, 204, 206 generated by the IDE system of the present embodiment. A first window 200 provides a main screen for resetting the hardware 10 (FIG. 1), invoking a particular program, and other high-level functions. A second window 202 shows source code for a program to be developed/debugged. A third window 204 shows various hardware resources, such as data registers and the like, associated with the particular device being manipulated. A fourth window 206 shows the debugger speedbar displaying various symbolic information, such as data structure information and the like.

It is understood that the debugger speedbar window 206 can include a wide variety of information types associated with embedded firmware development that facilitates developing and debugging a firmware program. Exemplary types of information include source files, code labels, data labels, names of data registers and names of index registers. It is understood that the term data label can refer to names of words, bytes, short words, and instances of structures. While known development tools may enable a user to obtain this information, the process can be cumbersome and time-consuming. For example, in certain known IDEs symbolic data structures can be viewed only after typing in the symbol names. This requires an intimate working knowledge of the symbol names in the code, which can be time-consuming and inefficient.

While shown and described as having discrete screens, it is understood that one or more screens can contain the display information described above. That is, the information can be displayed in various formats with the speedbar information shown for a selected portion(s) of one or more source programs to facilitate code debugging. Moreover, a statement referring to first, second, third and fourth screens may include a single screen having respective portions.

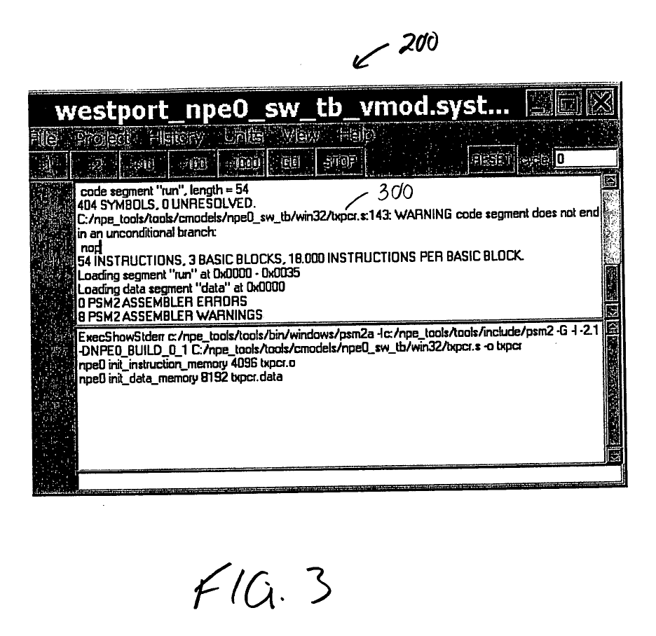

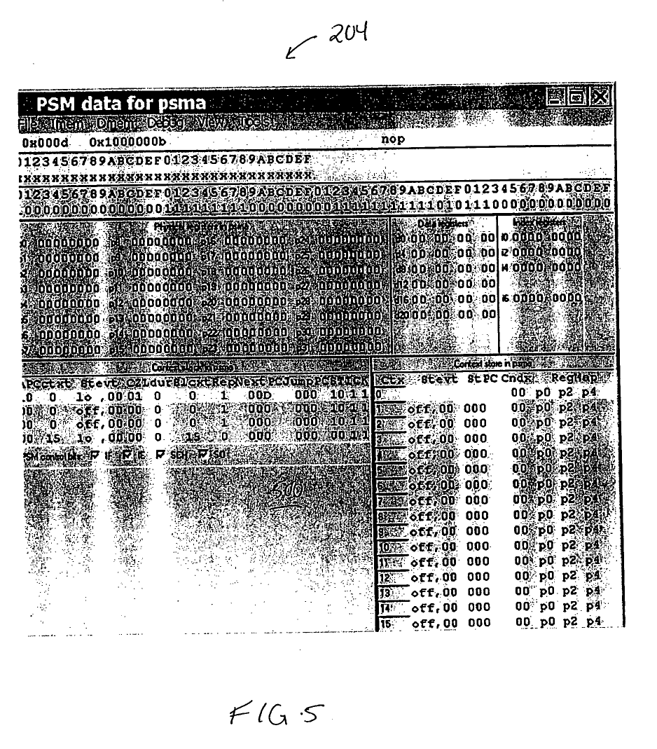

FIG. 3 shows a more detailed view of the main window 200 from which the user can invoke and control high-level function of the inventive IDE system. In one particular embodiment, the main window is 200 is generated after a program is selected, which can be done from the hardware resource screen 204 (FIG. 5), for example. The main screen 200 shows various information associated with the program, here shown as txpcr.c 300, such as assembler warnings and errors.

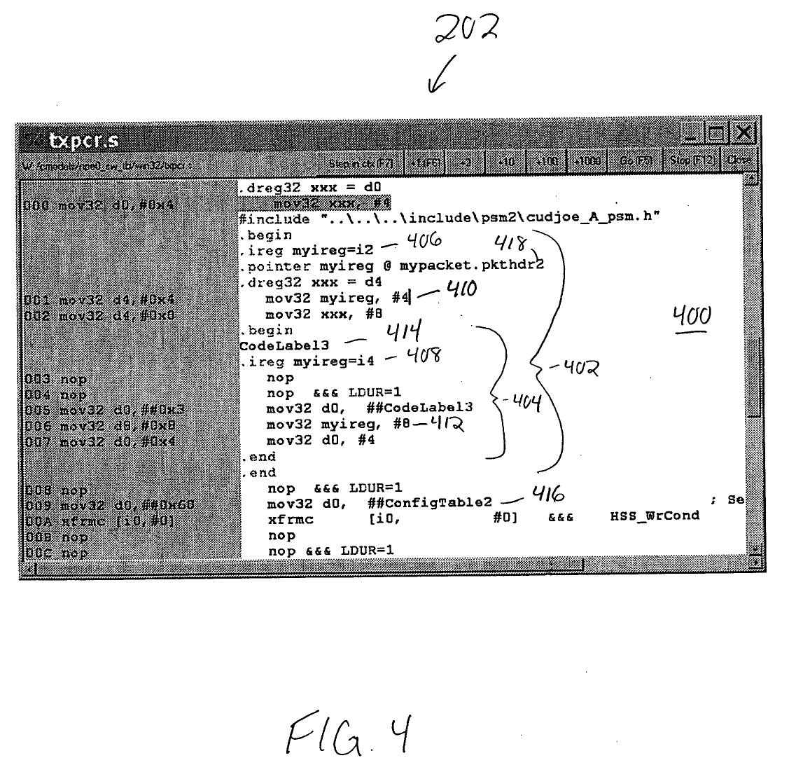

FIG. 4 shows a more detailed view of the source code window 202 for txpcr.s 400. The code window 202 displays program instructions for txpcr.s that include various programming instructions well known to one of ordinary skill in the art. The code 400 includes first and second begin/end loops 402, 404 that define respective code regions, as will be appreciated by one skilled in the art and discussed more fully below. The code 400 includes symbolic definitions, such as .ireg myireg=i2 406 within the first begin/end loop 402 and .ireg myireg=i4 408 within the second begin/end loop 404. As can be seen, the instruction mov32 myireg, #4 410, moves the value #4 into device register i4. In the second (inner) begin/end loop 404, the instruction mov32 myireg, #8 412 moves this value into device register i4. Thus, the device register to which myireg refers depends upon the begin/end loop association.

The source code 400 includes further instructions such as Codelabel3 414, which provides a location for subsequent “goto” instructions. A further instruction 416 makes reference to ConfigTable2. There is a pointer instruction 418 .pointer myireg @mypacket.pkthdr2 that includes the use of data structs, which can be viewed in the speedbar 206 as described more fully below.

FIG. 5 shows further details of the exemplary hardware resource window 204 of FIG. 2. The hardware resource window 204 show hardware resources 500 associated with a particular device, here an Intel IXP4XX processor. The window 204 lists physical registers p0-p31, data registers d0, d4, d8, d12, d16 and d20, and index registers i0, i2, i4, and i6, as well as the register contents. The hardware resource screen 204 further shows information relating to context store in psma (Program State Machine A) and context stack in psma. The exemplary hardware resource screen 204 will be readily understood by one of ordinary skill in the art. It is understood that any number of hardware resource windows can be generated, each of which can correspond to a programmable device and program.

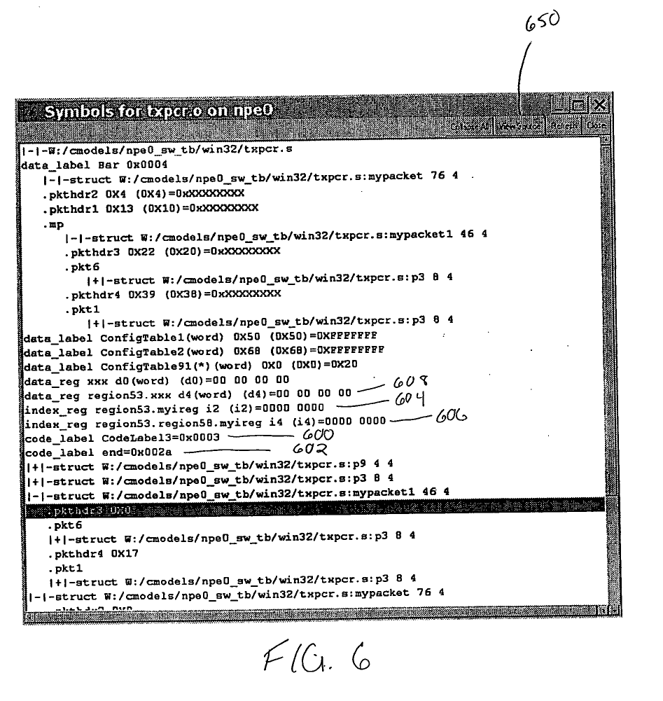

FIG. 6 shows an exemplary debugger speedbar 206 for program txpcr.s 300. The speedbar shows various symbol information and the like useful to a programmer attempting to debug a program. The speedbar 206 includes address locations 600, 602 for code-labels CodeLabe13 and end. The symbolic definitions for myireg are also shown. As can be seen, the resource association for myireg depends upon the location of the code, e.g., in which begin/end loop myireg is used. For example, at region53 604, which corresponds to the first begin/end loop 402 (FIG. 2) of source program txpcr.s, myireg refers to index register i2. Myireg refers to index register i4 in the second or inner code loop 404, which is identified as region 53.region58.myireg 606 as shown. Similarly, region53.xxx 608, which corresponds to the first begin/end loop 402, refers to data register d4. As can be seen, address and/or data values for the various symbols are displayed in the speedbar screen 206.

In an exemplary embodiment, the speedbar 206 further includes a view source code button 650 to facilitate viewing of source code associated with a particular symbol. For example, a user may select, e.g., via a computer mouse, a particular symbol and click the view source button 650 to view the source code for the selected symbol. The view source button 650 can generate a window to display the selected source program. Alternatively, source file information can be viewed by double-clicking on a [+] symbol associated with a listed source file.

It is understood that the speedbar can list information for named registers, data labels for the word, byte, short entities, as well as the names and addresses of the data labels referring to structures. The structures, and their fields (including substructures), are individually expandable to show their addresses and values of the word containing the start of the field. In an exemplary embodiment, items can be expanded by clicking on a [+] symbol and collapsed by clicking on a [−] in a conventional manner.

For code labels, the information generally includes the address of the label. For named registers, the register number, value, and size (for data registers) can be shown. For data labels, users may see the name, type (short, word, byte or structure), address, address of word containing the label address, and that word value.

In an exemplary embodiment, the information displayed by the speedbar xx is derived and calculated from data gathered during program load. This data is stored in memory until needed by the speedbar. By using the speedbar xx, a user can easily expand the main source file, expand structure instances, and read values at associated offsets. From a single window, with simple mouse clicks, a user can open source files, and see symbolic data.

While the development systems disclosed herein are applicable to programs in general, the presently disclosed embodiments are well-suited for embedded programs, which tend to be smaller than large application programs. The efficiencies afforded by the inventive system will be readily apparent over known IDEs, such as Microsoft Visual Studio, which requires a user to type the desired symbol name into a window and to locate source file information on a different menu or window.

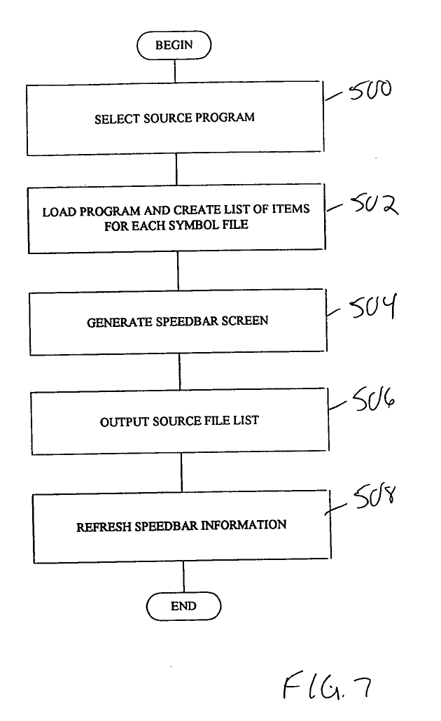

FIG. 7 shows an exemplary sequence of processing blocks for implementing an exemplary embedded software development system in accordance with the presently disclosed embodiments. In processing block 500, a user selects a program, e.g., source code, to be loaded and assembled in the main screen. The IDE system extracts information from the object file generated by the assembler. During the program load, in processing block 502, symbol files for the source code are parsed to create a list of items for each symbol file. Exemplary items include data labels, code labels, named index registers, named data registers, structures, and structure fields. These items can be formatted and stored for later use by the speedbar, as well as other debugging operations.

In processing block 504, a speedbar window is created by parsing the created lists and calculating the required information. In one particular embodiment, the speedbar is activated from a menu in the hardware resource screen. The source file list is then output in processing block 506. For example, during code expansion, for each symbol type (e.g., data_label code_label index_reg, data_reg, struct) a routine which can be referred to as ‘output_the_symbol_type’ can be invoked to call a symbol-type specific routine to output the line in the speedbar. If the symbol type is a data label referring to a structure, for each field the ‘output_the_symbol_type’ routine can be recursively called to output the field until the field is no longer a structure. As the user advances through the program being debugged, the system refreshes the information in the speedbar as the user advances, such as via go/stop, breakpoints and individual steps.

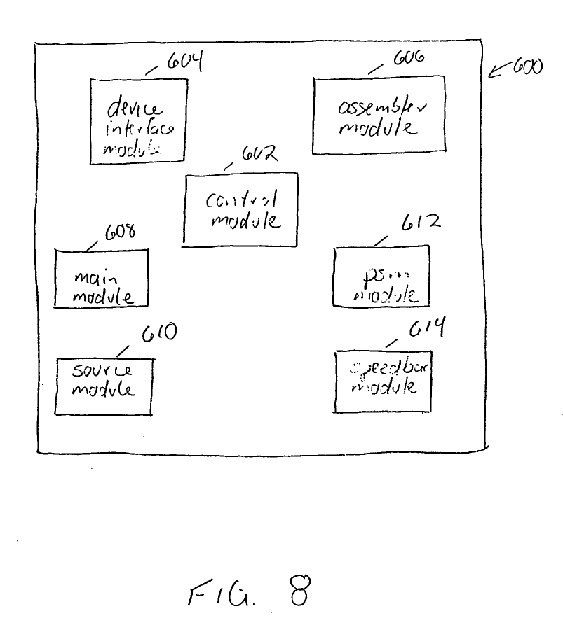

FIG. 8 shows a schematic depiction of an exemplary architecture 600 for an embedded programming system having a debugger speedbar. A control module 602 controls the overall system functionality. A device interface module 604 communicates with the device for which an embedded program is being developed. An assembler module 606 assembles the source program in a convention manner and generates errors and warnings in a manner well known to one of ordinary skill in the art.

A main module 608 generates a main screen, such as the main screen 200 of FIG. 2. A source module 610 generates a window for displaying program source code, such as the window 202 of FIG. 2. A psm module 612 generates a window for displaying hardware resources associated with the device, such as the window 204 of FIG. 4. And a speedbar module 614 generates a debugger speedbar, such as the speedbar 206 of FIG. 2.

It is understood that a wide variety of architectures can be used to implement an embedded programming system in accordance with the presently disclosed embodiments. It is further understood that various hardware and software implementations are possible.

The presently disclosed embodiments provide a system for embedded programming that enhances the productivity of processor code developers. The inventive system enables developers of microcode/assembly language/firmware embedded in processors and other programmable devices to be more productive by allowing them to view data structures in programs at a single glance, which may not require any key-strokes. The inventive system also allows developers to navigate more easily through code during debugging, which reduces the development time for firmware such as microcode for the Intel IXP4XX family of processors, as well as other similar microcode programs adopted from tools associated with other programmable devices.

One skilled in the art will appreciate further features and advantages of the above-described embodiments. Accordingly, the embodiments disclosed herein are not to be limited by what has been particularly shown and described, except as indicated by the appended claims. All publications and references cited herein are expressly incorporated herein by reference in their entirety.

1. A method of displaying embedded firmware program information, comprising:
displaying a first screen to interact with a user for high level function selections;
displaying a second screen to show hardware resources for a programmable circuit;
displaying a third screen to show source code for a plurality of source code programs to control the programmable circuit; and
displaying a fourth screen to show symbolic information associated with the displayed source code.

2. The method according to claim 1, further including displaying source code associated with a symbol selected by the user.

3. The method according to claim 2, further including displaying a view source button.

4. The method according to claim 1, wherein the symbolic information is associated with one or more of code labels, data labels, data register names, and index register names.

5. The method according to claim 1, further including displaying the symbolic information without typing by the user.

6. The method according to claim 1, further including displaying symbolic information associated with data structures.

7. The method according to claim 1, further including displaying a device enabling expansion of the displayed symbolic information.

8. The method according to claim 6, further including displaying address and value information associated with the data structures.

9. The method according to claim 1, further including parsing the source code to create a list items for symbols files associated with the source code.

10. The method according to claim 9, further including outputting symbolic information for a data structure recursively until resultant fields are no longer structures.

11. The method according to claim 1, further including displaying the symbolic information for particular regions of the source code.

12. The method according to claim 1, wherein the programmable circuit includes a network processor.

13. An embedded firmware development system, comprising:
a control module to control the system;
a device interface module coupled to the control module to communicate with a device to be programmed by the system;
an assembler module coupled to the control module to assemble source code;
a main module coupled to the control module to display a high-level function screen;
a source module coupled to the control module to display source code for at least two firmware programs;
a hardware resource module coupled to the control module to display hardware resources associated with the device to be programmed; and
a speedbar module coupled to the control module to display symbolic information associated with the source code.

14. The system according to claim 13, wherein the symbolic information includes at least one of code labels, data labels, data structures, data register names, and index register names.

15. The system according to claim 13, wherein the device includes a network processor.

16. An article comprising:
a storage medium having stored thereon instructions that when executed by a machine result in the following:
displaying a first screen to interact with a user for high level function selections;
displaying a second screen to show hardware resources for a programmable circuit;
displaying a third screen to show source code for a plurality of source code programs to control the programmable circuit; and
displaying a fourth screen to show symbolic information associated with the displayed source code.

17. The article according to claim 16, further including displaying source code selected by the user.

18. The article according to claim 16, further including displaying the source code selected by the user by clicking on a view source button.

19. The article according to claim 16, wherein the symbolic information is associated with one or more of code labels, data labels, data register names, and index register names.

20. The article according to claim 16, further including displaying the symbolic information without typing by the user.

21. The article according to claim 16, further including displaying address and value information associated with data structures.

22. The article according to claim 16, further including parsing the source code to create a list items for symbols files associated with the source code.

23. The article according to claim 16, further including outputting symbolic information for a data structure recursively until resultant fields are no longer structures.

24. The article according to claim 16, further including displaying the symbolic information for particular regions of the source code.
